(19) United States
(12) Patent Application Publication
(10) Pub. No.: US 2005/0188030 A1
(43) Pub. Date: Aug. 25, 2005

(54) Auto-forwarding and auto-delegating email folder control

(76) Inventor: Milan Hudecek, Caulfield North (AU)

Correspondence Address: Stephen D. Carver, Suite 800, 2024 Arkansas Valley Drive, Little Rock, AR, 72212-4147, US

(21) Appl. No.: 11/030,818

(22) Filed: Jan. 7, 2005

Related U.S. Application Data
(60) Provisional application No. 60/534,932, filed on Jan. 9, 2004.

(51) Int. Cl. G06F 15/16

(52) U.S. Cl. 709/206

(57) ABSTRACT

An email agent includes special folders enabling a busy executive to speed up forwarding of email messages, delegate their processing and obtain notification of the message processing. An Auto-Forwarding folder comprising various recipient choices automatically forwards selected message to desired recipients (or to a list of recipients). Optionally a predefined note may be tacked to the received, forwarded message. Alternative subfolders to identical recipients are made available, facilitating different treatments for emails forwarded to the same target. Automatic delegating functions are provided to inform the original sender of the status of a forwarded message. A special code inserted in the header of a return message from a delegate will inform the delegator's system that the return message is a copy of a reply to a previously delegated message, and the return message can be stored either in a standard InBox or a special InBox for copies of replies to delegated messages.

### CROSS REFERENCE TO RELATED APPLICATION

This application is based upon, and claims the filing date of, prior U.S. Provisional Patent Application Ser. No. 60/534,932, filed Jan. 9, 2004, and entitled Auto-Forwarding and Auto Delegating Email Folder Control, by inventor Milan Hudecek.

### BACKGROUND OF THE INVENTION

I. Field of the Invention

The present invention relates generally to software-controlled, Internet email programs. More particularly, the invention relates to an email system for automatically forwarding email messages and delegating tasks.

II. Description of the Prior Art

The use of email has grown exponentially over the last decade, and almost everyone using email in business is overwhelmed by the sheer volume of incoming email and the need to process it. Yet the tools used to send and receive email have not changed much, and offer the same basic structure within which email is received, processed and sent.

All email agents rely on an InBox-OutBox paradigm, where incoming mail is received in the InBox and outgoing email is sent from OutBox directory folders. Once the email is sent, it is moved from the OutBox to the Sent Box.

Apart from these main folders, there are usually also predefined folders for drafts, deleted messages, and a facility of a users to create their own folders and subfolders to suit their particular applications—however, all these additional folders have only a storage function, and do not in any other way participate in the process of sending or receiving messages. Such special role is reserved only to the InBox and OutBox, which currently represent the only gateways between the user's email system and the outside world.

For example, with the popular Microsoft E-mail program Outlook, incoming email is received in an InBox. All outgoing email must be placed to the OutBox (which is done automatically when a new email message is created). When the outgoing messages are sent, they are moved to the Sent Items folder. This well-established paradigm has been serving well in the past. Yet, it is time to move on and introduce new types of output folders which would provide new, faster and more efficient ways of processing email.

It happens frequently, that an email message is to be forwarded to another party. At present, this involves a series of actions. The action is initiated by clicking the “Forward” button. Then, one must select the addressee to whom the message is to be forwarded (either by typing the email address in, or by selecting it from an “address book”). Then, a short note at the top of the forwarded message is usually inserted. Finally, the “Send” button is clicked with the mouse to send the message.

With busy executives who receive a significant number of email messages a day, this repetitive process wastes significant time.

Yet, in most cases, the above situation can be automated: The number of associates to whom a typical email user frequently forwards messages is often limited. The short note at the top of the forwarded message is usually quite similar, for example “Peter, this is for your action please. Thanks, Michael.”

### SUMMARY OF THE INVENTION

Special folders within an email program are designed to Auto-Forward messages to designated recipients. Other folders Auto-Delegate tasks within a busy electronic workplace.

Thus a primary object is to provide an email client program that automatically forwards and delegates critical email.

Another object is to ease the workload of those who need to work with email, and are finding it harder and harder to cope with the ever-increasing flood of incoming email messages.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a pictorial view of a typical screen display for an email folder constructed in accordance with my invention;

FIG. 2 is a pictorial view of a “properties box” screen display for a subfolder within the “Auto-Forwarding” email folder;

FIG. 3 is a pictorial view of a typical screen display for an email folder with an alternative autoforwarding subfolder;

FIG. 4 is a pictorial view of a “properties box” screen display for one of the forwarding recipients of FIG. 3;

FIG. 5 is a pictorial view of a typical screen display for an email folder with auto-delegating functions constructed in accordance with my invention;

FIG. 6 is a pictorial view of a typical screen display for an alternative email folder comprising a special InBox for delegated messages; and,

FIG. 7 is a properties display for the preferred auto-delegate folder.

### DETAILED DESCRIPTION

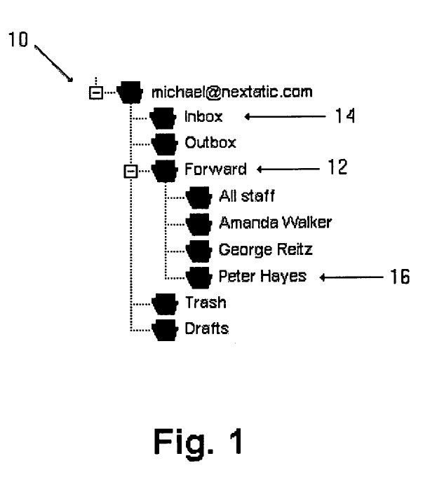

An email account 10 is seen in FIG. 1. An Auto-Forwarding folder 12 has been added, to shorten the steps and procedural requirements for forwarding emails. When messages are displayed from the InBox folder 14, the screen representation may be dragged into the Auto-Forward folder 12, for deposit into one of the autoforwarding subfolders labeled “All Staff”, “Amanda Walker” etc.

The user can create many desired subfolders within the Forward subfolder 12. Dragging a message from the InBox to a Forward subfolder will automatically forward the message to the desired recipient (or a list of recipients, such as “All staff”). In addition, the Auto-Forwarding function will automatically insert a predefined note in the received message and forward it to the desired recipient.

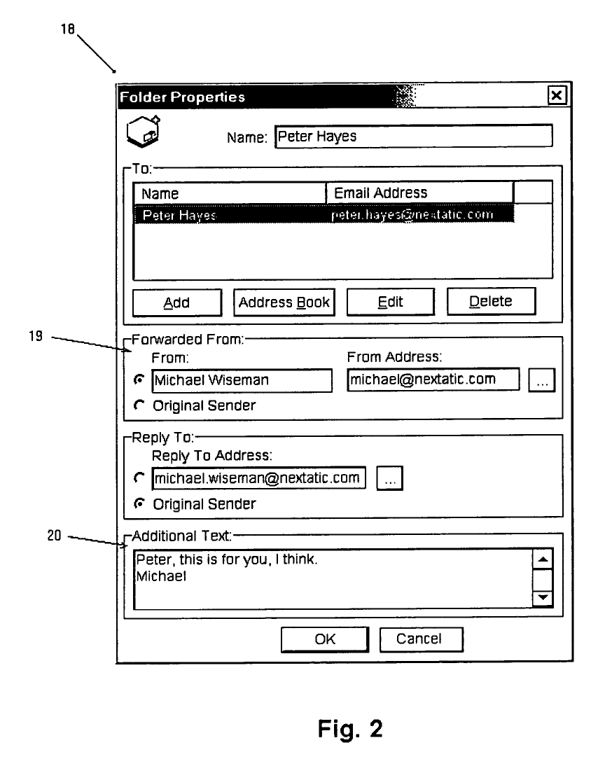

Each Forward subfolder will have associated Properties, which specify the behavior of the subfolder in more detail. For example, the subfolder 16 (FIG. 1), which, by way of example only, has been labeled “Peter Hayes,” will have associated “properties” as seen in the properties box 18 of FIG. 2. There is a space 19 (FIG. 2) within the Folder Properties that indicates from whom a message was forwarded. The name of the forwarding party is indicated on the left; the corresponding email address is located on the right. The rectangular space 20 at the bottom provides a space for general, explanatory text messages.

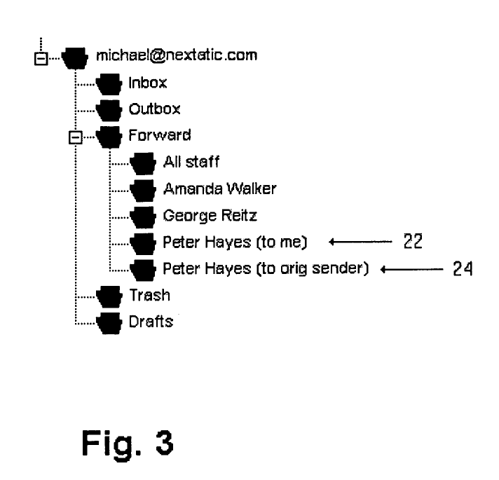

Referencing FIG. 3, alternative subfolders to the same recipient are possible within Autoforwarding subfolder 12. Note that hypothetical forwarding target “Peter Hayes” is listed in subfolders 22, 24 (FIG. 3). These subfolders 22, 24 differ only in one important detail—i.e., the reply-to address. The reply-to address is user-defined in the properties of the subfolders, and will determine whether the recipient (i.e. Peter Hayes) of the forwarded message will reply to the forwarder or to the original sender. A message to be forwarded that is dragged into subfolder 24 will indicate to the recipient (i.e. Peter Hayes) that he will be replying to the forwarding party. Similarly, a message to be forwarded that is dragged into subfolder 22 will indicate to the recipient (i.e. Peter Hayes) that his reply will go to the original sender.

Subfolders 22, 24 (FIG. 3) are preferably distinguished with customizable colors (for example, the icon 24 of the folder marked “Peter Hayes (to me)” could be made green—because it is “safer” if Peter Hayes replies to the forwarder, while icon 22 of “Peter Hayes (to orig sender)” could be made red, as replying of forwarded messages directly to the original sender can be dangerous as an internal message could be inadvertently sent out.

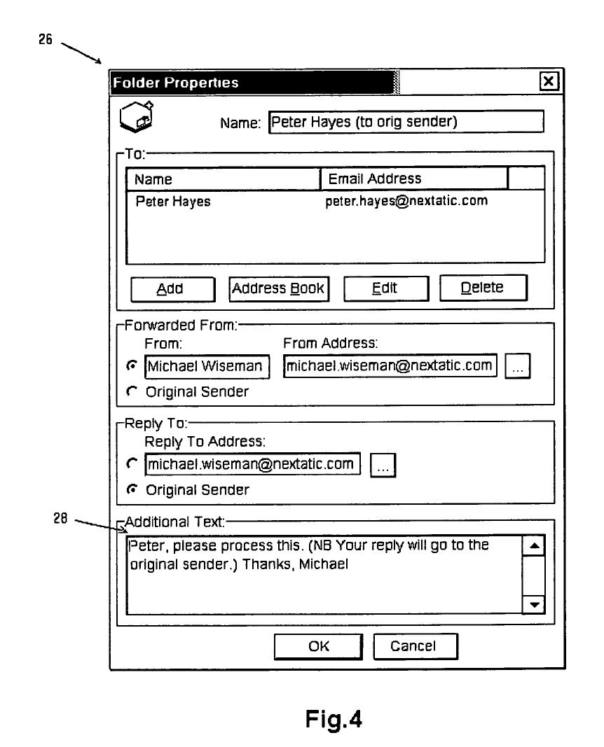

For the recipient of a forwarded message, a specific instruction can be made in the Properties display 26 (FIG. 4) which corresponds to and is derived from subfolder 22 (FIG. 3). The added instruction is made in the “Additional Text” box 28. The forwarding recipient (i.e. Peter Hayes in this example) will then receive a message with the following text inserted at the top:
“Peter, please process this. (NB Your reply will go to the original sender.) Thanks, Michael.”

Importantly, automatic delegating can be a vital feature. With a conventional state-of-the-art email application, if an email message is forwarded with the reply-to address being that of the original sender, then the forwarder never knows whether the “forwardee” in fact processed the message, unless it was copied back to him. In reality, a busy executive forgets that a message has been forwarded, amongst the many other messages he or she attends to in a day. This applies to both the traditional forwarding method in existing email applications, as well as the Auto-Forwarding Folder described above.

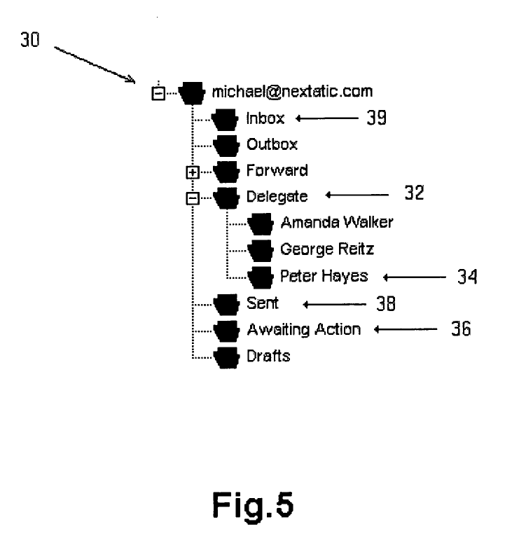

Automatic delegating functions are preferably accomplished with the email account 30 of FIG. 5, which, by way of example, is that displayed for hypothetical user michael@nextatic.com. Forwarding a message to a third party for processing is in fact an act of delegation. However, no delegation is complete if it does not provide a means of tracking progress and verifying that the task has been in fact accomplished. To provide a proper feedback method to verify that such delegation worked, the Auto-Delegating folder is proposed. Such Auto-Delegating Folder 32 (FIG. 5) is titled “Delegatee.” One of the possible recipients, again Peter Hayes by way of example, has a subfolder 34.

Auto-delegating functionality is quite similar to that of the Auto-Forward folder, however, the application keeps track of the “delegated” email message, and makes it possible to view their status. When a message is sent, then instead of the Sent folder as it would have been the case with a conventional state-of-the art email application, it is placed in the Awaiting Action folder 36 (FIG. 5).

When the recipient (the “delegate”) processes the message (i.e. by replying to the original sender), his email application will automatically copy this message to the “delegator”, with a special code inserted in the message header which will make the delegator's system understand that this is a copy of a reply to a previously delegated message. Once this reply is received by the delegator's system, the originally delegated message is moved from the Awaiting Action folder 36 to the Sent folder 38. The reply itself is placed in the InBox 39 (FIG. 5). This can be either a standard “one suits all” InBox, as is the case in FIG. 5, or a special InBox for copies of replies to delegated messages.

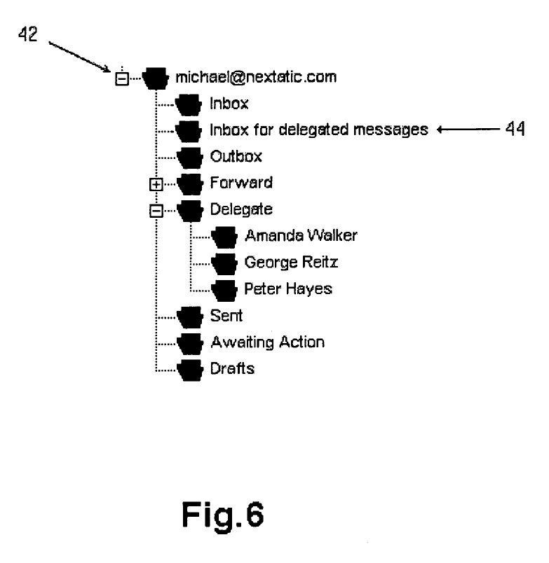

For example, email account 42 (FIG. 6) has a special InBox icon 44 for copies of replies to delegated messages. This allows the “delegator” (In this case “Michael) to examine his subordinates' responses to delegated messages separately, as these may deserve a different level of attention than messages received from the “outside world” which arrive in the standard InBox.

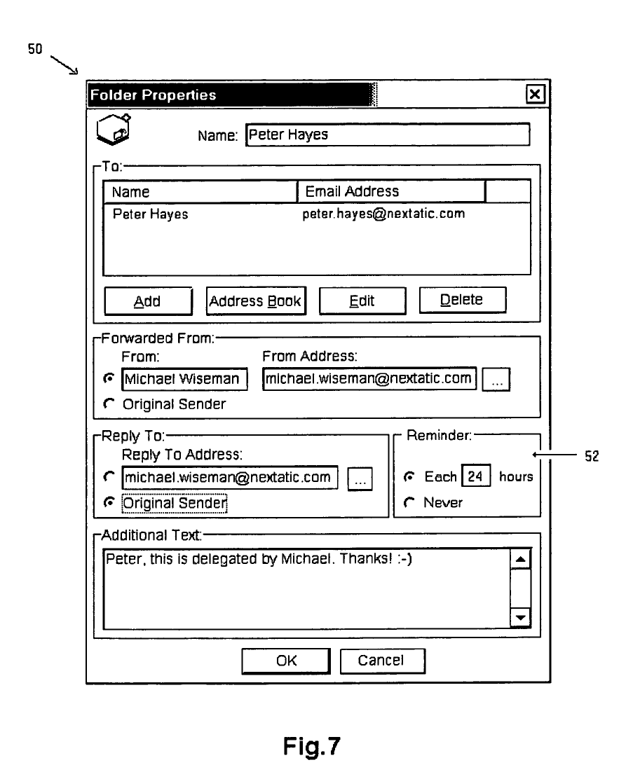

Properties of the Auto-Delegate Folder 32 of FIG. 5 are seen in the properties box 50 illustrated in FIG. 7. Referring to FIG. 7, as in previous examples, a message has been delegated from one Michael Wiseman to one Peter Hayes. There is an addition of a reminder time period: If the delegated message is not responded to within this preset time, the delegator's system will keep sending a reminder message to the delegate upon each such elapsed “reminder time” period, as selected in box 52, or until the delegator removes the message from the Awaiting Action folder. This has an intended application for example in a busy office, where such system will ensure that customer inquiries are being responded to in with minimum delays, and no messages remain ignored.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

1. A software controlled method for Auto-forwarding Email, the method comprising the steps of:
establishing an email account with a plurality of predefined folders, including an inbox, an outbox, a sent messages folder, a draft folder, an awaiting action folder, and a deleted messages folder;
providing an autoforwarding folder for receiving and automatically forwarding preselected messages from said inbox to selected recipients, the auto-forwarding folder comprising a plurality of forward subfolders, each forward subfolder intended for a selected email recipient or recipients;
automatically forwarding messages dragged from the InBox to a given autoforwarding subfolder to the desired recipient(s); and,
automatically inserting a predefined note to the desired recipient in each received message that is to be autoforwarded.

2. The method as defined in claim 1, including the steps of providing each autoforwarding subfolder with an associated properties object that stores preselected information relevant to the recipient of emails specified in that forwarding subfolder, and the step of automatically adding said preselected information to all emails forwarded from that forwarding subfolder.

3. The method as defined in claim 2, including the further step of indicating from whom a message was forwarded and the email address of from whom the message was forwarded in each message to be autoforwarded.

4. The method as defined in claim 2, including the further step of providing alternative subfolders for the same recipient within each autoforwarding subfolder for specifying alternative reply-to addresses.

5. The method as defined in claim 1 including the step of providing a Delegating folder to provide proper feedback to a forwarder to verify that delegated actions were completed by the recipient.

6. The method as defined in claim 5 including the further step of including subfolders in said delegating folder for specific delegatees.

7. The method as defined in claim 6, including the further step of, when a delegatee processes a message by replying to an original sender, automatically copying this message to the delegator and inserting a special code in the message header for enabling the delegator's system to understand that this is a copy of a reply to a previously delegated message.

8. A software controlled method for Auto-forwarding and Auto-delegating Email, the method comprising the steps of:
establishing an email account with a plurality of predefined folders, including an inbox, an outbox, a sent messages folder, a draft folder, an awaiting action folder, and a deleted messages folder;
providing an autoforwarding folder for receiving and automatically forwarding preselected messages from said inbox to selected recipients, the auto-forwarding folder comprising a plurality of forward subfolders, each forward subfolder intended for a selected email recipient or recipients;
automatically forwarding messages dragged from the InBox to a given autoforwarding subfolder to the desired recipient(s); and,
providing a Delegating folder to provide proper feedback to a forwarder to verify that delegated actions were completed by the delegatee.

9. The method as defined in claim 8 including the further steps of:
including subfolders in said delegating folder for specific delegatees; and,
when a delegatee processes a message by replying to an original sender, automatically copying this message to the delegator and inserting a special code in the message header for enabling the delegator's system to understand that this is a copy of a reply to a previously delegated message.

10. The method as defined in claim 8, including the further step of automatically inserting a predefined note to the desired recipient in each received message that is to be autoforwarded.

11. The method as defined in claim 10, including the steps of providing each autoforwarding subfolder with an associated properties object that stores preselected information relevant to the recipient of emails specified in that forwarding subfolder, and the step of automatically adding said preselected information to all emails forwarded from that forwarding subfolder.

12. The method as defined in claim 11, including the further step of indicating from whom a message was forwarded and the email address of from whom the message was forwarded in each message to be autoforwarded.

13. The method as defined in claim 12, including the further step of providing alternative subfolders for the same recipient within each autoforwarding subfolder for specifying alternative reply-to addresses.

14. The method as defined in claim 13 including the further steps of:
including subfolders in said delegating folder for specific delegatees; and,
when a delegatee processes a message by replying to an original sender, automatically copying this message to the delegator and inserting a special code in the message header for enabling the delegator's system to understand that this is a copy of a reply to a previously delegated message.
